(19) United States
(12) Patent Application Publication
(10) Pub. No.: US 2014/0114526 A1
(43) Pub. Date: Apr. 24, 2014

(54) Safety apparatus for a vehicle

(71) Applicant: SICK AG, Waldkirch (DE)

(72) Inventor: Frank ERB, Waldkirch (DE)

(73) Assignee: SICK AG, Waldkirch (DE)

(21) Appl. No.: 14/057,181

(22) Filed: Oct. 18, 2013

(30) Foreign Application Priority Data
Oct. 22, 2012 (EP) 12189437.2

(51) Int. Cl. G05D 1/00

(52) U.S. Cl. CPC G05D 1/0055
USPC 701/28; 701/70

(57) ABSTRACT

A safety apparatus (200) is set forth for a vehicle (100), in particular a driverless vehicle, having at least one optoelectronic sensor (10) for detecting objects in a monitored zone (18), having a protected field determination unit (34) for the dynamic definition of a protected field (206) within the monitored zone (18), having a protected field monitoring unit (36) for recognizing unpermitted intrusions into the protected field (206) as a protected field incursion and having a safety output (32) for outputting an emergency stop signal or braking signal to a vehicle control (102) of the vehicle (100) in the case of a protected field incursion. The protected field determination unit (34) is in this respect configured to define the protected field (206) with reference to an emergency stop trajectory (210).

The invention relates to a safety apparatus for a vehicle comprising at least one optoelectronic sensor and to a method for securing a vehicle in accordance with the preambles of claims 1 and 20 respectively.

Optoelectronic sensors have been used for a fairly long time as driver assistance systems or for the automatic navigation of vehicles. Since an important function is recognizing obstacles, sensors of this kind are usually adapted for distance determination. Different processes are known for this purpose, for example stereoscopic camera systems. A further distance-measuring sensor type is a laser scanner which transmits brief light pulses and measures the time of flight of light up to the reception of reflections of the objects in the field of view. The scan beam is periodically deflected over an angular range so that the object distribution in the scan plane is acquired in the monitored zone by the distance and angle of recognized objects.

In safety engineering, the application comprises recognizing unauthorized intrusions into protected fields and thereupon generating a safety-directed switch-off signal. If therefore a person appears within the protected field in front of the vehicle, the vehicle is braked to avoid an accident.

A trend is becoming apparent in the market for driverless transport systems in the logistics area to increase vehicle speeds, to increase the throughput per vehicle for cost reduction and to close the gap to the main competition, the manned lift truck. In addition, holonomic drives are being developed and used which allow a practically unlimited movement in all three degrees of freedom and make predictions on the movement of the vehicle even more difficult. Both aspects increase the challenges for a reliable security.

If, for example, a situation-independent static protected field were to be placed around the vehicle which covers all conceivable speeds and travel paths, it would have to be planned with such large safety margins that unnecessary emergency braking procedures would constantly occur. To obtain sufficient availability, it is therefore known to select on a situation-by-situation basis a protected field stored in the sensor in a preconfigured form by utilizing corresponding inputs of the sensor. A securing of a vehicle with the named higher speed or a holonomic drive would, however, in particular at best be conceivable due to statistical errors with a large number of fields which have to be respectively individually configured and tested. This huge effort in the putting into operation can in principle be avoided by dynamic fields. No solutions are, however, known with which dynamic fields are automatically defined with sufficient security and flexibility.

DE 10 2005 054 359 A1 discloses a protective device for a vehicle having an optical sensor. It determines the travel direction and/or speed by locating objects. One of a plurality of stored protected fields is selected with reference to this measured variable or a validation of a read-in protected field is carried out. The problem is not solved by this of preconfiguring the saved protected fields with a justifiable effort or of defining the protected field to be read in. In addition, the direction of travel and the speed are not determined accurately enough with a lack of orientation points or with mutually confusable orientation points in the vehicle environment and even an exact knowledge of these two parameters is only suitable for determining the zone actually to be secured with limitations.

To come to grips with the effects of ambiguities in the speed determination, EP 2 428 862 A1 proposes measuring the speed vector a multiple of times. A corresponding single protected field is determined for all speed vectors measured in this manner whose probability that they correspond to the actual sped vector is larger than a limit value. The protected field monitored overall is then the contour of the individual protected fields.

In EP 2 339 376 B1, a protected field of a specific width and length is first predefined, with this dimensioning being able to depend on the travel speed. An attempt is subsequently made to fit this protected field into the vehicle environment without a protected field incursion by variations of a rotation and a lateral displacement with respect to the longitudinal vehicle axis. If this is not successful, an emergency stop is triggered. This procedure is particularly suitable in aisles where emergency braking procedures would be triggered with a purely static protected field due to the lateral boundaries of the aisle on only slight deviations from a centered straight-ahead movement even though there is actually no danger.

The underlying assumptions in the calculation of dynamic protected fields using a speed vector are frequently no longer correct and the known solutions are therefore not usable in particular with faster vehicles or those with holonomic drives.

It is therefore the object of the invention to improve the securing of a vehicle with the aid of dynamic protected fields.

This object is satisfied by a safety apparatus for a vehicle having at least one optoelectronic sensor and by a method for securing a vehicle in accordance with claims 1 and 20 respectively. In this respect, the invention starts from a dynamic protected field which is therefore not configured in advance, but is rather defined in dependence on the current situation, for example with reference to the environment of the vehicle or its movement status. Since the protected field provides security in various directions under certain circumstances, it does not necessarily have to be contiguous. The plurality of part protected fields which then arise are, however, still called the protected field in their entirety. The defining of the dynamic protected field takes place with reference to an emergency stop trajectory. This is the movement path which the vehicle would take if an emergency brake were initiated immediately. The recognition therefore underlies the invention that only the emergency stop trajectory determines the actual danger area.

The invention has the advantage that a securing is made possible in any desired emergency stop trajectories. Their extent depends on the physical circumstances, for example on the handling of an automatic vehicle control, and is not artificially restricted by assumption to the vehicle environment or to the possible vehicle movements. Dynamic protected fields are generated which largely correspond to the ideal danger region and are only as large as necessary, i.e. are only longitudinally extended in the actual travel direction corresponding to the braking path and otherwise remain narrow in the non-endangered zones. The availability is thereby increased, unnecessary emergency braking procedures are avoided and the use is also made possible more flexibly and also in an environment limited more by boundaries. A suitable dynamic protected field can also be defined with the aid of the invention for vehicles having higher speeds of 3 m/s and more instead of the at most 1.5 m/s still used in many conventional cases as well as with holonomic drives.

A communication connection is preferably provided between the vehicle control and the protected field determination unit to transfer the emergency stop trajectory from the vehicle control to the protected field determination unit. Since the information on the emergency stop trajectory is critical for safety, the communication path is preferably safe or failsafe in the sense of relevant safety standards. The vehicle control is responsible for the movement of the vehicle and decides the travel path on an emergency stop in order, for example, to evade an obstacle such as a wall during braking. The vehicle control therefor best knows the future path of the vehicle in the case of an emergency stop. This information source is utilized by transmission of the respective potential emergency stop trajectory currently planned in the vehicle control as the best prognosis of the actual danger by the vehicle. For the determination of the emergency stop trajectory, for example, the vehicle control utilizes measured data of the vehicle such as the current speed and position, measured data of the environment such as the position of walls and of movable objects, or advance knowledge, for instance a map of the environment with known obstacles or the maximum braking acceleration and the tightest curve radius with which the vehicle could carry out the emergency braking procedure due to its property. Since the safety apparatus uses the emergency stop trajectory calculated from this, it is no longer of decisive importance whether the vehicle control has found a particularly suitable emergency stop trajectory. The vehicle control will in any case actually use just this emergency stop trajectory so that it is also exactly the path of the vehicle which has to be secured.

The protected field determination unit is preferably configured to calculate an emergency stop trajectory. This is useful, for example, when the vehicle control does not calculate an emergency stop trajectory or if this is not accessible. In principle, the protected field determination unit reproduces the process with which a vehicle control determines the emergency stop trajectory. A simplified model is preferably used since it is not the purpose of the invention to replace the vehicle control, although the way is conceivable that conversely the vehicle control uses the emergency stop trajectory determined in this manner.

The protected field determination unit is preferably configured to extrapolate the emergency stop trajectory from a covered travel path, from previous and/or from current speed information of the vehicle, in particular in that it is assumed that the vehicle continues its travel path in a straight-line movement or in a curve with a constant radius. This is an example for a simplified model for predicting the emergency stop trajectory. The previous or current movement behavior is carried forward. Since the past cannot always be carried on into the future, this model only approximately deals with higher speeds, holonomic drives and overall with movements not visible from the past. A higher-ranking action of the vehicle control, for instance an abrupt change of direction to evade an obstacle, cannot be recognized in advance and a suitable dynamic protected field is then also not always defined.

The protected field determination unit is preferably configured to receive or to calculate the emergency stop trajectory as a discrete sequence of elemental movements or to divide the emergency stop trajectory into a discrete sequence of elemental movements. The elemental movements are therefore in principle infinitesimal movement steps and practically part sections of the emergency stop trajectory which are suitable for a step-wise digital processing. Complex emergency stop trajectories can thus also be processed.

The elemental movements preferably have a pose, an arc and/or a straight piece. The pose is used to secure a start position. An arc covers movements having direction changes and a straight piece describes a translation, for example a forward movement, a reverse movement or, particularly in the case of holonomic drives, also a sideward movement. Any desired movement paths can be composed from these and only very few different types of elemental movements have to be processed.

A respective one elemental protected field is preferably stored in the protected field determination unit for each elemental movement. These elemental protected fields then no longer have to be calculated in operation. They can rather be configured and tested in advance. Since only one respective elemental protected field is necessary per elemental movement, the configuration effort remains extremely small and in particular completely independent of the handling.

The protected field determination unit is preferably configured to define the protected field as a superposition of the elemental protected fields of the discrete sequence of elemental movements with respect to the emergency stop trajectory. In other words, the protected field used in operation is the OR superposition of the elemental protected fields along the emergency stop trajectory. The total braking path is thereby protected.

The protected field determination unit is preferably configured to define a contour for a superposition of the elemental protected fields of the discrete sequence of elemental movements with respect to the emergency stop trajectory as the protected field. In this respect, for example, a convex envelope can be determined or a simple geometrical shape is predefined and a search is made as to the position in which and the smallest scaling at which it circumscribes the superposition of the elemental protected fields. The contour represents a simplification of the outer contour, for example for visualization, and a specific safety buffer.

A plurality of predefined protected fields are preferably stored in the protected field determination unit, with the protected field determination unit selecting one of the stored protected fields, preferably the smallest, for the dynamic definition of the protected field which protected field contains all elemental protected fields of the discrete sequence of elemental movements with respect to the emergency stop trajectory. Only the stored protected fields have to be tested, starting from the smallest, for this purpose until with an AND link no more points of the superposition to be protected remain. A hybrid thereby arises between a selection of preconfigured protected fields and the determination of the protected field from an emergency stop trajectory.

The safety apparatus preferably comprises a plurality of mutually registered optoelectronic sensors for expanding its range of view. It is effectively a plurality of sensors which act as a single sensor. The sensors are for this purpose connected to one another directly, via the safety apparatus or via a further safety control. Regions masked by the vehicle with respect to one of the sensors can thereby also be detected, for example, and a 360° panoramic view can also be achieved with smaller angles of view.

The protected field determination unit and/or the protected field monitoring unit is preferably integrated into the optoelectronic sensor. The optoelectronic sensor thus takes over parts of the safety apparatus or is even identical thereto. Alternatively, the defining of the dynamic protected fields and/or their evaluation take place in a safety control which is connected to the sensors, which communicates with the vehicle control or is integrated into the vehicle control.

The optoelectronic sensor is preferably a laser scanner or a 3D camera. Both kinds of sensors deliver reliable information on objects and allow a distance measurement so that a flexible definition of protected fields and their secure monitoring for unpermitted protected field intrusions is possible.

Provision is made in an advantageous further development to equip a vehicle with a sensor in accordance with the invention. The term vehicle is to be understood very widely and includes every mobile machine, that is also a robot. A failsafe vehicle control in this respect is in communication connection with the safety apparatus to communicate the emergency stop trajectory and optionally to use the sensor data for orientation and for determining a suitable travel path.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

FIG. 1 a sectional representation of a laser scanner;

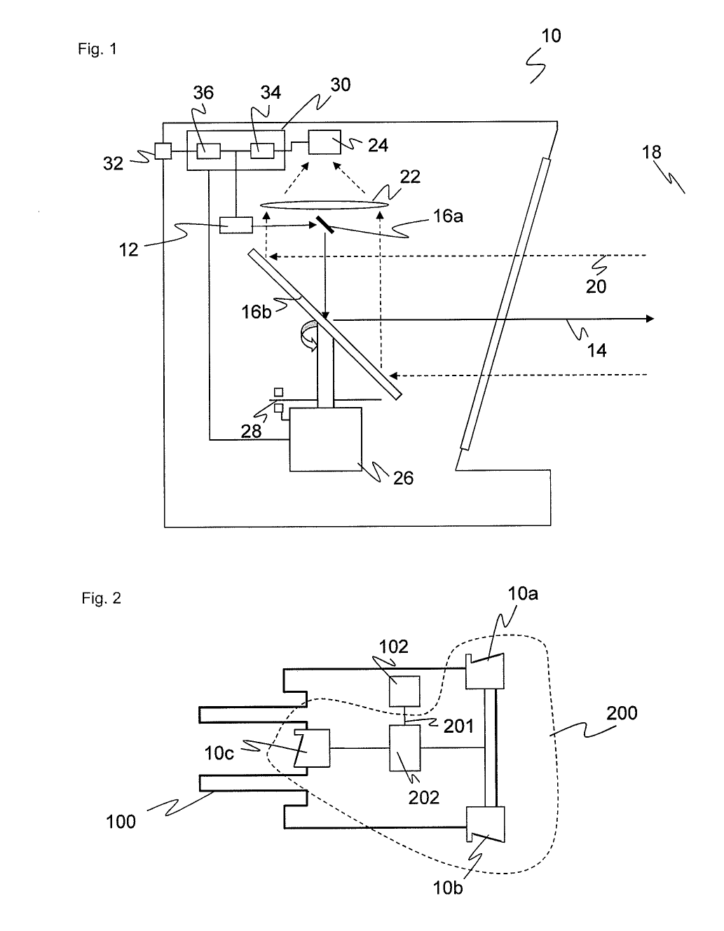

FIG. 2 a plan view of a vehicle with a safety apparatus and a plurality of laser scanners;

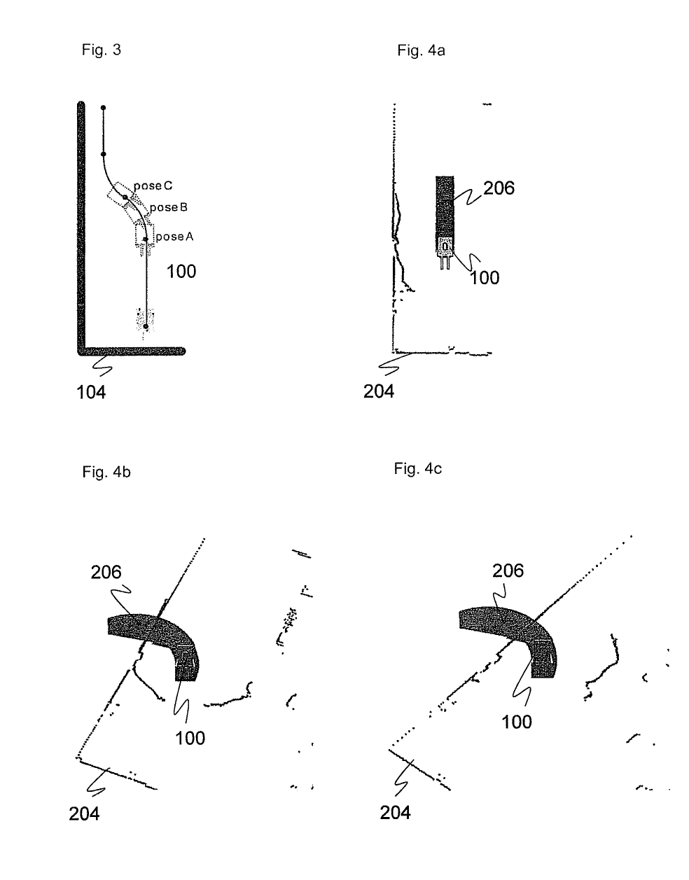

FIG. 3 an exemplary representation of a travel path with poses A-C;

FIGS. 4a-c exemplary measured data of a scanner and protected fields defined on the basis of extrapolation of a speed vector in the poses A-C of FIG. 3;

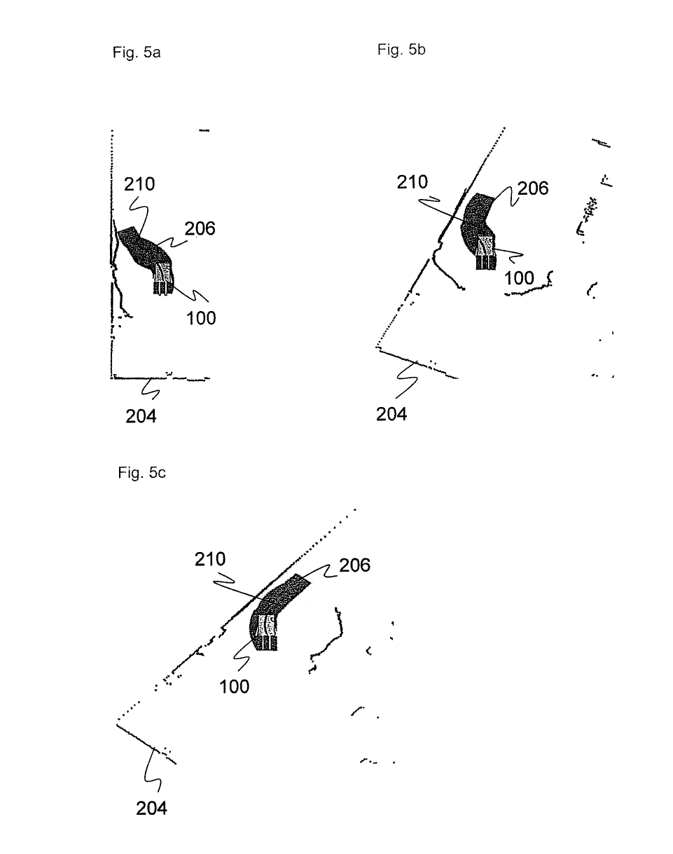

FIGS. 5a-c exemplary measured data of a scanner and protected fields defined with reference to an emergency stop trajectory transmitted by a vehicle control in the poses A-C of FIG. 3;

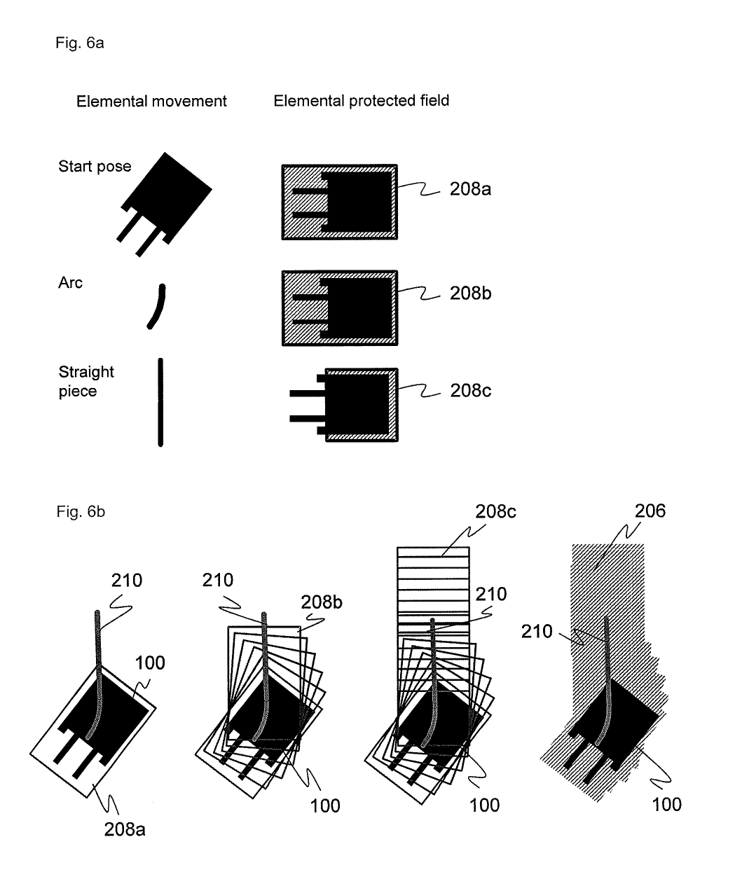

FIG. 6a a representation of possible elemental movements into which an emergency stop trajectory can be broken down and of the associated elemental protected fields;

FIG. 6b a plurality of stages of the superposition of elemental protected fields for defining a dynamic protected field with reference to an emergency stop trajectory;

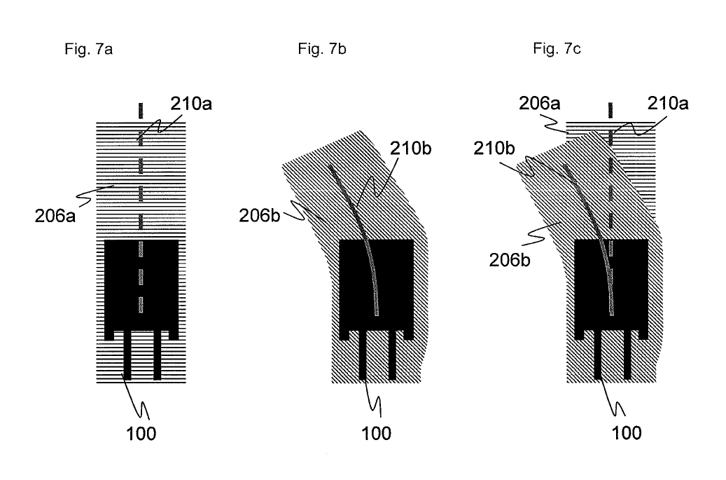

FIG. 7a an exemplary protected field on extrapolation of a forward movement shortly before a curve;

FIG. 7b an exemplary protected field on the forward movement shortly before a corner in accordance with FIG. 7a, but with knowledge of the curve with reference to an emergency stop trajectory handed over by a vehicle control; and

FIG. 7c a comparative superposition representation of the protected fields in accordance with FIGS. 7a and 7b.

The function of a distance-measuring laser scanner 10 will first be described with reference to FIG. 1 as an embodiment of a sensor which can be used as a safety apparatus in accordance with the invention or as a part thereof. Other sensors, in particular distance-measuring sensors, such as stereo cameras or camera chips based on the time of flight of light, for instance in accordance with the principle of photon mixing detection, are known per se and can be used instead of the laser sensor 10 or to complement it.

A light beam 14 which is generated by a light transmitter 12, for example by a laser, and which has individual light pulses is directed into a monitored zone 18 via light deflection units 16a-b and is there remitted by an object which may be present. The remitting light 20 again arrives back at the laser scanner 10 and is detected there by a light receiver 24, for example a photodiode, via the deflection unit 16b and by means of an optical receiving system 22.

The light deflection unit 16b is made as a rule as a rotating mirror which rotates continuously by the drive of a motor 26. The respective angular position of the light deflection unit 16b is detected via an encoder 28. The light beam 14 generated by the light transmitter 12 thus sweeps over the monitored zone 18 generated by the rotational movement. If a reflected light signal 20 reflected by the light receiver 24 is received from the monitored zone 18, a conclusion can be drawn on the angular position of the object in the monitored zone 18 from the angular position of the deflection unit 16b by means of the encoder 28.

In addition, the time of flight of the individual laser light pulses is determined from their transmission up to their reception after reflection at the object in the monitored zone 18. A conclusion is drawn on the distance of the object from the laser scanner 10 from the time of flight of light while using the speed of light. This evaluation takes place in an evaluation unit 30 which is connected for this purpose to the light transmitter 12, to the light receiver 24, to the motor 26 and to the encoder 28. Two-dimensional polar coordinates of all objects in the monitored zone 18 are thus available via the angle and the distance.

The actual aim of the evaluation in a laser scanner 10 used for securing is to recognize protected field incursions and thereupon to provide a safety signal to a safety output 32 (OSSD, output signal switching device). For this purpose, the evaluation unit 30 calculates the location of an object in the monitored zone 18 via the angular data and the distance data. In a protected field determination unit 34, limits for a protected field within the monitored field 18 are defined in a manner explained in more detail with reference to FIGS. 2 to 7, for instance in the form of corner points of a frequency polygon. A protected field monitoring unit 36 checks whether one of the detected objects is located within the protected field. This is recognized as a protected field incursion provides the object is not exceptionally permitted in the protected field because it is very small or is only detected very briefly, for example. On a protected field incursion, the safety signal is output to the safety output 32.

The evaluation unit 30 with the protected field adjustment unit 34 and the protected field monitoring unit 36 can, deviating from the representation, also be implemented totally or partly outside the laser scanner 10. The laser scanner 10 is therefore selectively a safety apparatus for securing a vehicle alone or in connection with external evaluations. It is furthermore conceivable to collate the data of a plurality of laser scanners 10 and to evaluate them together for safety-critical events.

FIG. 2 shows a schematic plan view of a vehicle 100, here a forklift truck, which is controlled in a driverless manner by a vehicle control 102 and is in this respect secured by a safety apparatus 200. Laser scanners 10a-c in accordance with FIG. 1 as examples for optoelectronic sensors are attached to the vehicle 100 at a plurality of sides for monitoring the vehicle environment and as parts of the safety apparatus 200. The laser scanners 10a-c are connected to a safety control 202 and are mutually registered, i.e. a common coordinate system is known to merge the measured data. The safety control 202 optionally comprises a common protected field determination unit and a common protected field monitoring unit or they are partly or fully integrated, as in FIG. 1, into the laser scanners 10a-c and are only connected to one another at a higher level via the safety control 202 or via a network connection (e.g. safe field bus) in order thus to form the common protected field determination unit or the common protected field monitoring unit.

If the safety apparatus 200 recognizes a protected field incursion, a safe switch-off signal is output to the vehicle control 102 to slow down the vehicle 100 or to initiate an emergency stop. The vehicle control 102 for this case has calculated an emergency stop trajectory on which it comes to a standstill as fast as possible and without any collision. This emergency stop trajectory is conversely preferably handed over periodically or on request to the safety apparatus 200 in order to define suitable protected fields for the securing of the braking path on the emergency stop trajectory. There is preferably a failsafe connection 201 for communication between the safety apparatus 200 and the vehicle control 100.

Instead of an emergency braking procedure, the vehicle control 102 can also decide, in cooperation with the safety apparatus 200, on finding a new emergency stop trajectory whose associated dynamic protected field would not be infringed. The vehicle 100 could then stop on this alternative braking path and is therefore not additionally at risk by the recognized protected field intrusion. Furthermore, a warning field can be positioned before the protected field, with an intrusion into the warning field not yet triggering an emergency stop, but rather first only a warning function such as a klaxon. It is also conceivable to use an additional upstream protected field, for example to reduce the speed without braking the vehicle down to a standstill via an emergency stop.

FIG. 3 shows an exemplary travel path of the vehicle 100 in which the vehicle first moves at some distance in parallel with a wall 104, then approaches it and then continues its travel at a shorter distance in parallel with the wall 104. In this respect, three poses A to C are marked during the travel which will be looked at more exactly in the following.

FIGS. 4a-c show cumulative measured data 204 of the laser scanners 10a-c as well as protected fields 206 in the poses A to C. The calculation of the protected fields 206 takes place in this embodiment with reference to an emergency stop trajectory which is derived in the safety apparatus 206 from the instantaneous movement state of the vehicle 100. The information on the movement state originates from the vehicle control 102 or is derived from the measured data 204, for example by again recognizing natural or artificial orientation features at a plurality of points in time. A speed vector in two or three degrees of freedom can then be determined from this. An extrapolation of the emergency stop trajectory from the speed sector and a calculation of a protected field 206 from this emergency stop trajectory are based on a plurality of assumptions:
The dimensioning of the dynamic protected field 206 is independent of the current location of the vehicle 100. Otherwise it would be necessary to switch over to another protected field depending on the position.
The vehicle 100 moves only on circular tracks with a constant radius of curvature r=v/., where a straight line is a circle with an infinite curvature.
The radius of curvature also remains constant on an emergency stop.

A speed vector namely does not provide any more information and can in particular not predict differing control interventions of the vehicle control 102.

In the images in accordance with FIGS. 4a-c, the vehicle 102 moves purely by way of example at 2.8 m/s on the straight lines and at 40°/s at 1.8 m/s in the S curve. Whereas the protected field 206 very probably coincides with the braking path of the vehicle control 102 on the initial straight piece, this is at the latest in the pose A in accordance with FIG. 4a infinitesimally before the curve entry and is anyway not the case in the poses B and C in accordance with FIGS. 4b and 4c within the curve. The protected field 206 defined solely on the basis of the speed vector clearly projects into the wall 104. The vehicle control 102 will not select this braking path to avoid a collision with the wall 104. The protected field 206 admittedly provides better security than a static protected field in a linear forward direction, but does not completely cover the danger area.

The safety control 200 therefore takes over the emergency stop trajectory of the vehicle control 102 as a basis for the defining of the protected fields 206 in a preferred embodiment. This is therefore that potential braking path which the vehicle control 102 would presently select while including its total knowledge of the vehicle 100 and its environment to avoid accidents if an emergency stop occurs. The protected fields 206 which arise in this respect in poses A to C are shown in FIGS. 5a-c. The protected fields 206 here correspond in an almost ideal manner to the actual danger areas since the emergency stop trajectory receives the information that the vehicle control 102 will guide the vehicle along the S curve in the case of an emergency braking procedure to evade the wall 104. It is these danger areas which have to be monitored for an ideal securing by the safety control 200 with its laser scanners 10a-c.

Independently of whether the emergency stop trajectory is obtained by a calculation as explained with reference to FIG. 4 or by handing over from the vehicle control 102 as explained with reference to FIG. 5, the defining of the protected field 206 can take place particularly simply by breaking down the emergency stop trajectory into so-called elemental movements in an embodiment. For this purpose, FIG. 6a shows three exemplary elemental movements at the left side from which practically any desired emergency stop trajectories can be composed. In this respect, it is a start pose, an arc and a straight piece. Since the elemental movements are infinitesimal steps within the framework of what is possible in a calculation aspect in a predefined digital module, curves of practically any desired kind can be composed by arcs of different curvature and by a number of straight pieces suitable for the required length. There is no longer any restriction to circular paths having a constant radius.

An elemental protected field 208a-c is respectively associated with the elemental movements as shown on the right side of FIG. 6a. The elemental protected field 208a-c just secures the infinitesimal movement step on the emergency stop trajectory for the associated elemental movement.

FIG. 6b shows in four steps how the protected field 206 matching the emergency stop trajectory 210 in FIG. 6a is defined with the aid of elemental movements and elemental protected fields 208. In the first step, the elemental protected field 208a is added to the start pose. In the second step, a plurality of elemental protected fields 208b are added for arcs in sections of the curve of the emergency stop trajectory 210. In the third step, a plurality of elemental protected fields 208c are added for a straight piece on the subsequent forward movement along the emergency stop trajectory 210. Subsequently, in a fourth step, the protected field 206 is formed as a superposition, that is algorithmically as an OR link of all elemental protected fields 208a-c used. It is conceivable in a further step to provide the superposition with a safety buffer and to smooth it in that a contour, for instance a convex envelope or a surrounding geometrical shape (bounding box) is sought. This is, however, frequently rather cosmetic and can in an extreme case even give rise to unnecessary difficulties by additional calculation effort and over-large protected fields 206 with corresponding availability problems. In another embodiment, it is not the superposition itself which is used as the protected field 206, but rather that protected field is sought from a plurality of protected fields 206 precalculated, for example using a number of discrete speed intervals, and stored which coincides as closely as possible to the superposition. As a rule, this requires additional effort, but has the advantage that the usable protected fields 206 are kept under control.

The procedure explained with reference to FIG. 6 shows how a dynamic protected field 206 arises as an output from a predefined emergency stop trajectory 210 as an input. FIG. 4 shows exemplary results for a simple model calculation of the emergency stop trajectory 210 based on the speed vector of the vehicle; FIG. 5 shows an emergency stop trajectory predefined by the vehicle control 102. In principle, the safety control 200 itself can also use a more complicated model while including the physics of the vehicle 100 and its environment to generate a realistic emergency stop trajectory as from the vehicle control 102. The usual division of work between the vehicle control 102 and the securing by the safety apparatus 200 is thus given up, however. In addition, it is possible that the safety control 200 admittedly generates a suitable emergency stop trajectory 210, but the vehicle control 102 nevertheless uses a different one so that the predictive force is limited. The best information source is accordingly the vehicle control 102, insofar as it can be used as an information source. This is, however, not always the case; for instance when the vehicle control 102 only serves as a driver assistant for a human driver or if no transfer of the emergency stop trajectory is provided and possible.

FIG. 7 again shows a comparison of a protected field 206a which is defined by an emergency stop trajectory from an extrapolation of the speed vector and of a protected field 206b from an emergency stop trajectory of the vehicle control 102. In this respect, the travel path is selected exactly such that the vehicle 100 is currently still moving in a straight line, but is directly about to travel a curve. The speed vectors does not face into the future curve. A sensor such as the laser scanner 10 can very generally always only serve to recognize current or past physical properties. The past travel path and the current speed vector, however, do not always allow reliable conclusions on the future curve, at least not if the decision on the curve travel is made in another instance and is not mandated by the environment at all.

Consequently, a dynamic protected field 206a as in FIG. 7a, which is based on a speed vector calculated from the sensor data, is also still straight ahead directly before a curve and not in the direction of the curve since the extrapolated emergency stop trajectory 201 does not take the curve into account. The vehicle control 102, in contrast, is already aware at this point in time, as shown in FIG. 7b, that the emergency stop trajectory 210b of the braking path extends into the curve. A dynamic protected field 206b defined from this correspondingly takes account of the curve and therefore substantially better secures the danger area. In FIG. 7c, the two emergency stop trajectories 210a-b and the protected fields 206a-b defined therefrom are placed over one another for comparison. In addition to a common overlap region, the protected field 206a from the extrapolation of the speed vector shows an exclusively monitored part zone and a defective zone which is only covered by the other protected field 206b. Both prevent the function of the safety apparatus 200. The exclusively monitored part zone can trigger unnecessary emergency stops and impairs the availability, whereas protected field incursions are overlooked in the defective zone and the safety is thus reduced.

1. A safety apparatus (200) for a vehicle (100) having at least one optoelectronic sensor (10) for detecting objects in a monitored zone (18), having a protected field determination unit (34) for the dynamic definition of a protected field (206) within the monitored zone (18), having a protected field monitoring unit (36) for recognizing unpermitted intrusions into the protected field (206) as a protected field incursion and having a safety output (32) for outputting an emergency stop signal or braking signal to a vehicle control (102) of the vehicle (100) in the case of a protected field incursion, wherein the protected field determination unit (34) is configured to define the protected field (206) with reference to an emergency stop trajectory (210).

2. The safety apparatus (200) in accordance with claim 1, wherein the vehicle (100) is a driverless vehicle.

3. The safety apparatus (200) in accordance with claim 1, wherein a communication connection (201) is provided between the vehicle control (100) and the protected field determination unit (36) to transmit the emergency stop trajectory (210) from the vehicle control (100) to the protected field determination unit (36).

4. The safety apparatus (200) in accordance with claim 3, wherein the communication connection comprises a secure communication connection.

5. The safety apparatus (200) in accordance with claim 1, wherein the protected field determination unit (36) is configured to calculate an emergency stop trajectory (210).

6. The safety apparatus (200) in accordance with claim 5, wherein the protected field determination unit (36) is configured to extrapolate the emergency stop trajectory (210) from a covered travel path, from previous and/or from current speed information on the vehicle (100).

7. The safety apparatus (200) in accordance with claim 6, in which it is assumed that the vehicle (100) continues its travel path in a straight-line movement or in a curve with a constant radius.

8. The safety apparatus (200) in accordance with claim 1, wherein the protected field determination unit (36) is configured to receive or to calculate the emergency stop trajectory (210) as a discrete sequence of elemental movements or to divide the emergency stop trajectory (210) into a discrete sequence of elemental movements (210).

9. The safety apparatus (200) in accordance with claim 8, wherein the elemental movements have a pose, an arc and/or a straight piece.

10. The safety apparatus (200) in accordance with claim 8, wherein a respective elemental protected field (208a-c) is stored in the protected field determination unit (36) for every elemental movement.

11. The safety apparatus (200) in accordance with claim 10, wherein the protected field determination unit (36) is configured to define the protected field (206) as a superposition of the elemental protected fields (208a-c) of the discrete sequence of elemental movements with respect to the emergency stop trajectory (210).

12. The safety apparatus (200) in accordance with claim 10, wherein the protected field determination unit (36) is configured to define a contour for a superposition of the elemental protected fields (208a-c) of the discrete sequence of elemental movements with respect to the emergency stop trajectory (210) as the protected field (206).

13. The safety apparatus (200) in accordance with claim 10, wherein a plurality of predefined protected fields are stored in the protected field determination unit (36), and wherein the protected field determination unit (36) selects one of the stored protected fields for the dynamic definition of the protected field (206), which protected field contains all elemental protected fields (208a-c) of the discrete sequence of elemental movements with respect to the emergency stop trajectory (210).

14. The safety apparatus (200) in accordance with claim 13, wherein the protected field determination unit (36) selects the smallest stored protected field.

15. The safety apparatus (200) in accordance with claim 1, further comprising a plurality of mutually registered optoelectronic sensors (10a-c) for expanding its range of view.

16. The safety apparatus (200) in accordance with claim 1, wherein the protected field determination unit (36) and/or the protected field monitoring unit (34) is integrated into the optoelectronic sensor (10).

17. The safety apparatus (200) in accordance with claim 1, wherein the optoelectronic sensor (10) is a laser scanner or a 3D camera.

18. A vehicle (100) comprising a safety apparatus (200) having at least one optoelectronic sensor (10) for detecting objects in a monitored zone (18), having a protected field determination unit (34) for the dynamic definition of a protected field (206) within the monitored zone (18), having a protected field monitoring unit (36) for recognizing unpermitted intrusions into the protected field (206) as a protected field incursion and having a safety output (32) for outputting an emergency stop signal or braking signal of the vehicle (100) in the case of a protected field incursion,
wherein the protected field determination unit (34) is configured to define the protected field (206) with reference to an emergency stop trajectory (210); and further comprising a failsafe vehicle control (102) which is in communication connection (201) with the safety apparatus (200).

19. The vehicle (100) in accordance with claim 18, said vehicle being a driverless vehicle.

20. A method of securing a vehicle (100) wherein at least one optoelectronic sensor (10) detects objects in a monitored zone (18) about the vehicle (100) and unpermitted intrusions into a protected field (206) dynamically defined within the monitored zone (18) are recognized as protected field incursions, wherein in the case of a protected field incursion an emergency stop signal or braking signal is output to a vehicle control (102) of the vehicle (100), wherein the protected field (206) is defined with reference to an emergency stop trajectory (210) for the vehicle (100).
